(19) United States
(12) Patent Application Publication
(10) Pub. No.: US 2016/0324712 A1
(43) Pub. Date: Nov. 10, 2016

(54) INVERSION TABLE WITH NECK SUPPORT

(71) Applicant: Pure Global Brands, Inc., West Palm Beach, FL (US)

(72) Inventor: Mitchell Carlin, West Palm Beach, FL (US)

(21) Appl. No.: 14/705,142

(22) Filed: May 6, 2015

(51) Int. Cl. A61H 1/02; A63B 71/00

(52) U.S. Cl. CPC A61H 1/0229; A63B 71/0054

(57) ABSTRACT

The present invention describes an inversion table with neck support for providing an additional mechanism for reducing the risk of injury and allowing a user to remain on the device when partially or fully inverted. The inversion table with a neck support contains a base frame structure, a body support structure pivotably or rotatably connected to the base frame structure, a lower extremity fastening assembly, and a second assembly for securing or supporting one or more portions of a user to the inversion table. The second assembly preferably includes one or more neck supports.

### FIELD OF THE INVENTION

The present invention relates to exercise equipment, and to exercise equipment useful for alleviating back pain and providing other health benefits; and more particularly to an inversion table used to alleviate back pain and provide other health benefits having safety features designed to minimize the risk of neck and spinal injuries associated with being placed in an inverted or partially inverted position.

### BACKGROUND OF THE INVENTION

Numerous types of exercise equipment have been developed to provide users with a mechanism to provide some type of health benefit, whether cardiovascular, muscle building, or some type of therapeutic relief. Inversion therapy is designed to provide relief to one or more portions of the spine using gravity. The therapy utilizes a device, such as an inversion table to help an individual relieve a compressed spine under the theory that hanging upside down so that an individual's head is positioned at a lower point than his/her feet results in decompression of at least a portion of the spine. In addition, inversion therapy is believed to provide the following benefits: relieve general back pain by providing full-spine traction, relieve joint pressure through stretching and elongating muscles, increase circulation by stimulating the lymphatic system to increase flow of fluids, maintain body height by reversing the natural shrinking process associated with sleep.

Inversion tables are known in the art. For example, U.S. Pat. Nos. 7,500,939; 7,857,741; and 7,867,154 are illustrative examples of such inversion tables. While such inversion tables are popular and are thought to have a beneficial effect on individual users, care must be undertaken when using such devices. The main functionality of inversion tables is to allow the user to position themselves in an upside down position or at various angles in which his/her head is lower than his/her feet. As such, each device is provided with some type of ankle/foot support which allows the user some stability when positioned on the device in an inverted position. The leg based support structures offer some protection; however, being in an inverted state places the user in a compromising position. Should the user's foot slip or disengage from the foot support, the user is subject to increased risk of serious injury as a result of trauma to the head or shoulder resulting from the lack of further mechanisms or structures to prevent falling off. Moreover, while the user may be able to extend their hands down to the ground, given the unnatural upside down position, such motion may also result in damage to the back, shoulder, or outstretched arms or wrists.

Therefore, what is needed in the art is an inversion table for use in inversion therapy which is designed to minimize the risks of neck and spinal injury.

### SUMMARY OF THE INVENTION

The present invention describes an inversion table with neck support, thereby providing an additional mechanism for reducing the risk of injury and allowing a user to remain on the device when partially or fully inverted. The inversion table with a neck support contains a base frame structure, a body support structure pivotably or rotatably connected to the base frame structure, a first assembly for securing a first component of a user's body to the inversion table and a second assembly for securing or supporting one or more second components of a user's body to the inversion table.

Accordingly, it is an objective of the present invention to provide an inversion table designed to protect an individual from injury by minimizing the risks associated with placing an individual in an inverted or partially inverted position.

It is a further objective of the present invention to provide an inversion table designed to protect an individual from injury having two independent mechanisms designed to prevent injury should the individual fall from the device while in use.

It is yet another objective of the present invention to provide an inversion table designed to minimize the risk of neck or spinal injury.

It is a still further objective of the invention to provide an inversion table having at least one neck support device designed to minimize the risk of neck or spinal injury.

It is a further objective of the present invention to provide an inversion table having a lower extremity fastening assembly in combination with at least one neck support device designed to minimize the risk of neck or spinal injury.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a front perspective view of an inversion table with neck support in accordance with the present invention;

FIG. 2 is a back perspective view of the inversion table with neck support in accordance with the present invention with the inversion table shown in a fully inverted position;

FIG. 3 is a front perspective view of the inversion table with neck support in accordance with the present invention with the inversion table shown in a partially inverted position;

FIG. 4 is a side view of the inversion table with neck support in accordance with the present invention with the inversion table shown in an upright position;

FIG. 5 is a partial exploded view of the inversion table with neck support in accordance with the present invention;

FIG. 6 is an exploded view of an illustrative embodiment of a neck support structure in accordance with the present invention;

FIG. 7 is a perspective view of the neck support structure shown in FIG. 6;

FIG. 8 is a perspective view of an illustrative example of a portion of a backrest support frame;

FIG. 9 is a partial view of the inversion table with neck support illustrating the rotation of the neck support showing the positioning in front of and in back of the body support structure;

FIG. 10 is a front perspective view of an alternative embodiment of the inversion table with neck support in accordance with the present invention;

FIG. 11 is a back perspective view of the inversion table with neck support shown in FIG. 10;

FIG. 12 is a perspective view of an alternative embodiment of the inversion table with neck support in accordance with the present invention;

FIG. 13 is a perspective view of an alternative embodiment of the inversion table with neck support in accordance with the present invention;

FIG. 14 is a front view of the inversion table with neck support in accordance with the present invention in which an individual user is shown in an inverted orientation;

FIG. 15 is a side view of the inversion table with neck support in accordance with the present invention in which an individual user is shown in an inverted orientation;

FIG. 16 is a side view of the inversion table with neck support in accordance with the present invention in which an individual user is shown in a partially inverted orientation;

FIG. 17 is a side view of the inversion table with neck support in accordance with the present invention in which an individual user is shown in an alternative partially inverted orientation.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

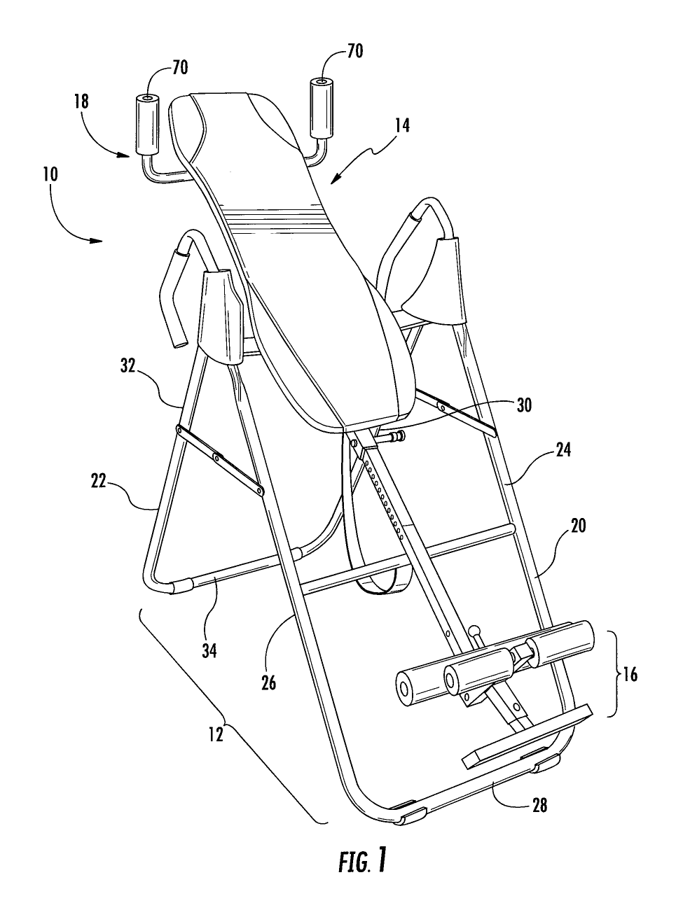

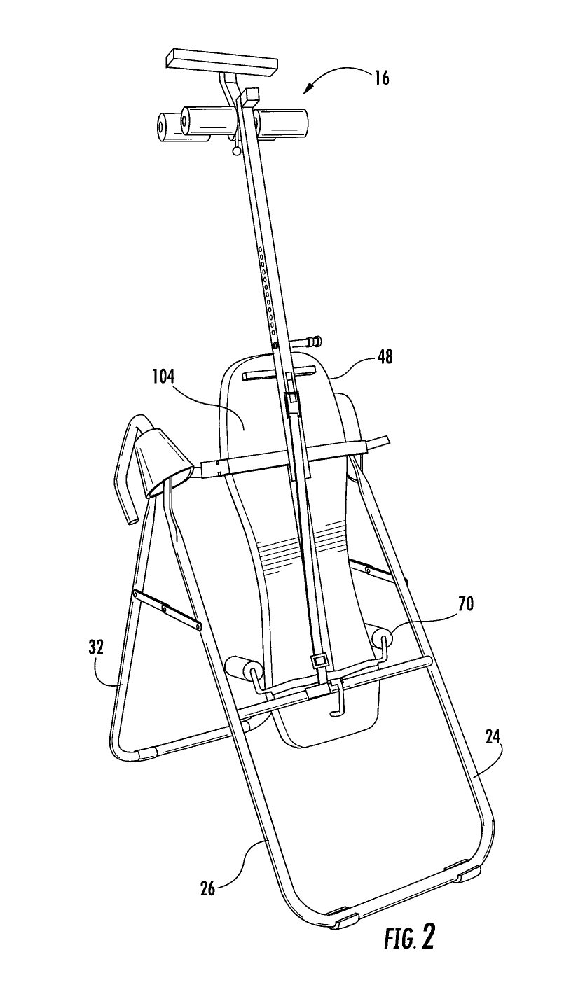

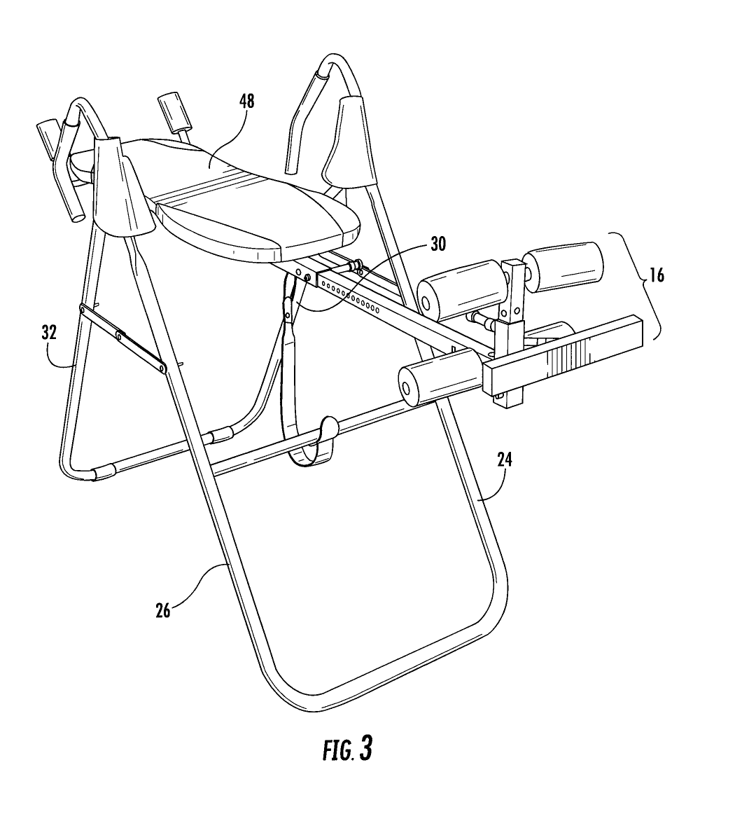

Referring to FIGS. 1-5, an improved inversion table with neck support, referred to generally as 10, is shown. The inversion table with neck support 10 contains a base frame structure assembly 12, a body support structure assembly 14 pivotably or rotatably connected to one or more portions of the base frame structure assembly 12, first member 16 for securing or supporting one or more portions of a user to the inversion table, illustrated herein as a lower extremity fastening assembly, and second member 18 for securing or supporting one or more portions of a user to the inversion table, illustrated herein as a neck support structure 70. In an alternative embodiment, the inversion table with neck support 10 may not include the lower extremity fastening assembly 16.

The base frame structure assembly 12 comprises a front base frame 20 and a rear base frame 22. The front base frame 20 comprises a pair of elongated vertical tubes 24 and 26 separated by an elongated horizontal tube 28. The rear base frame 22 comprises a pair of elongated vertical tubes 30 and 32 separated by an elongated horizontal tube 34. Both the front base frame horizontal tube 28 and the rear base frame horizontal tube 34 form a foot-like base support to provide stability and contact with a surface such as a floor 35 or mat (not illustrated). Alternatively, the front base frame 20 and the rear base frame may not include horizontal tubes 28 and 34. In this embodiment, the elongated tubes 24, 26 and 30, 32 act as the feet contacting the surface. The size of the elongated tubes 24, 26, 30, and 32 may have a fixed length or may be designed to provide for adjustable lengths. The elongated tube 26 and the elongated tube 32 are spaced apart and linked by center bar 34. The elongated tube 24 and elongated tube 30 are spaced apart and linked by center bar 36. Each of the center bars 34 and 36 can be uniform in length or designed to be foldable to allow the base frame structure assembly 12 to collapse into a compact position for storage. As shown, the center bar 34 has a first bar 34A which connects to elongated tube 26, a second bar 34B connected to elongated tube 32 and a hinge member 34C interconnecting the first bar 34A and the second bar 34B. The center bar 36 has a first bar 36A which connects to elongated tube 24, a second bar 36B connected to elongated tube 30 and a hinge member 36C interconnecting the first bar 36A and the second bar 36B. An intermediate cross bar member 37 connects the elongated tubes 24 and 26.

The body support structure assembly 14 contains a backrest support frame 38 having a first vertical bar 40 or plate and a plurality of horizontally arranged bars 42, 44, and 46 thereabout. Each of the horizontally arranged bars 42, 44, and 46 are secured to a body support structure, illustrated herein as a cushion or pad 48. The body support structure 48 is sized and shaped to support an individual when the individual is resting on the pad in an upright orientation or position, inverted position, or positions in between.

The horizontally arranged bar 44 is coupled to the base frame structure assembly 12 using a plurality of connector sheets and plates so as to allow the base frame structure assembly 12 and body support cushion 48 attached to the backrest support frame 38 to rotate or pivot about a pivot point 39. For example, each of the elongated tubes 24, 26, 30, and 32 may contain plates 41 at each distal end which secure to an interconnector plate 43. Attached to the interconnector plate is a portion of the base frame structure assembly 12. Inversion handle bars 45 and 47 can also be connected to base frame structure assembly 12 through the interconnector plate 43. Such rotation provides a user's body resting on the body support cushion 48 to traverse between a first upright position and a second inverted position, or various positions in between.

A bottom end 50 of the body support structure vertical bar 40 secures to the lower extremity fastening assembly 16. The lower extremity fastening assembly 16 includes a body height adjustment tube 52 which is inserted into the bottom end 50 of the body support structure vertical bar 40 and secured thereto using a plug with pin 51 and a long plug with spring 53 into openings 55. An adjustable leg hold tube 54 is inserted into the body height adjustment tube 52. A spring, not illustrated, is secured to the rear of the body height adjustment tube 52 using bolts, washers, and lock nuts. The lower extremity fastening assembly 16 further includes foam roller tubes 56 and a plurality of foam rollers 58. A foot rest plate 60 is slid into the bottom of the body height adjustment tube 52 and secured using bolts, washers, and lock nuts. An L-shaped hook 60 attaches through holes within the portions of the base frame structure assembly 12 and is secured using a spring 62 and washers and nuts 64.

The horizontally arranged bar 42 positioned at a top end 68 of the body support structure vertical bar 40 is preferably adapted to secure to one or more neck support structures 70. The neck support structures 70 are designed to provide the inversion table with neck support 10 with enhanced safety features to minimize the risk of various injuries to the user when inverted or placed in other various rotated positions. Accordingly, the neck support structures 70 allow the user to remain on the body support cushion/pad 48 (either in the inverted or partially inverted orientation) should the user become completely or partially dislodged from the lower extremity fastening assembly 16. These structures therefore, prevent the user from directly falling on their head or tearing/straining a ligament in their wrists as the user reaches out to the floor.

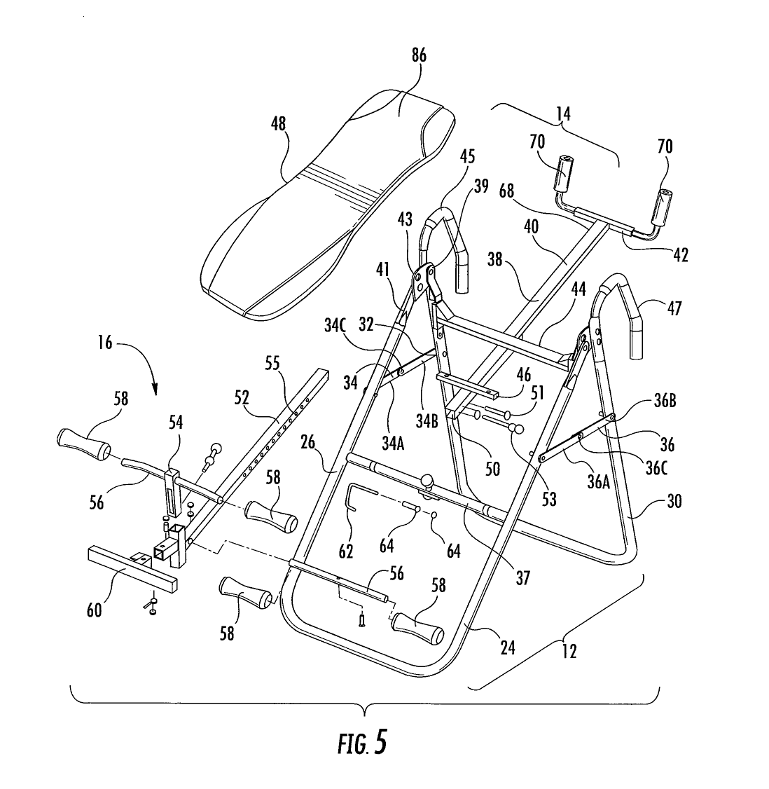

Referring to FIGS. 6 and 7, an illustrative example of the neck support structure 70 is shown. The neck support structure 70 comprises a first end 72, a second opposing end 74, and a main body 76 there between. The main body 76 is shaped to include a first generally vertically orientated portion 78, and a second generally horizontally orientated portion 80 separated by a region 82 having a fixed or adjustable curvature. The curvature may form an angle α which may be a value from between greater than zero (0) degrees and less than one hundred eighty (180) degrees.

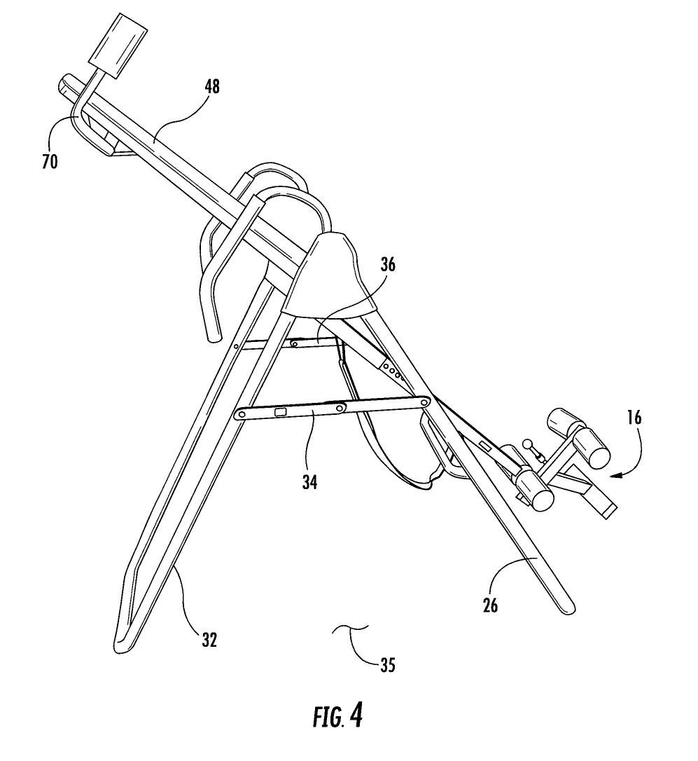

The generally vertically orientated portion 78 preferably secures to a portion of the backrest support frame 38 through, for example, openings 83 sized and shaped to receive securing devices such as a screw 85 (see FIG. 7). The generally vertically orientated portion 78 extends upwardly and away from the backrest support frame 38. The generally horizontally orientated portion 80 is designed to preferably extend in a perpendicular or generally perpendicular manner from the longitudinal axis 84 of the vertically orientated portion 78, extending away from or out past the front surface 86 (see FIG. 5) of the body support cushion 48 when secured to the backrest support frame 38. Coupled to the first end 72 is a cushioning device, illustrated herein as a foam cylindrical member 88. The foam cylindrical member 88 may be coupled to the first end 72 through the use of chemical adhesives or may simply form a frictional fit that can be snapped on/off through inserting the first end 72 within the opening 90 and into internal lumen 92. While the neck support structure 70 is shown as a single unitary member fixed in length, the support structure 70 may include multiple telescoping units in which adjacent units are sized and shaped to slide within a preceding units to allow for portions of the neck support structure 70 to be extended or retracted.

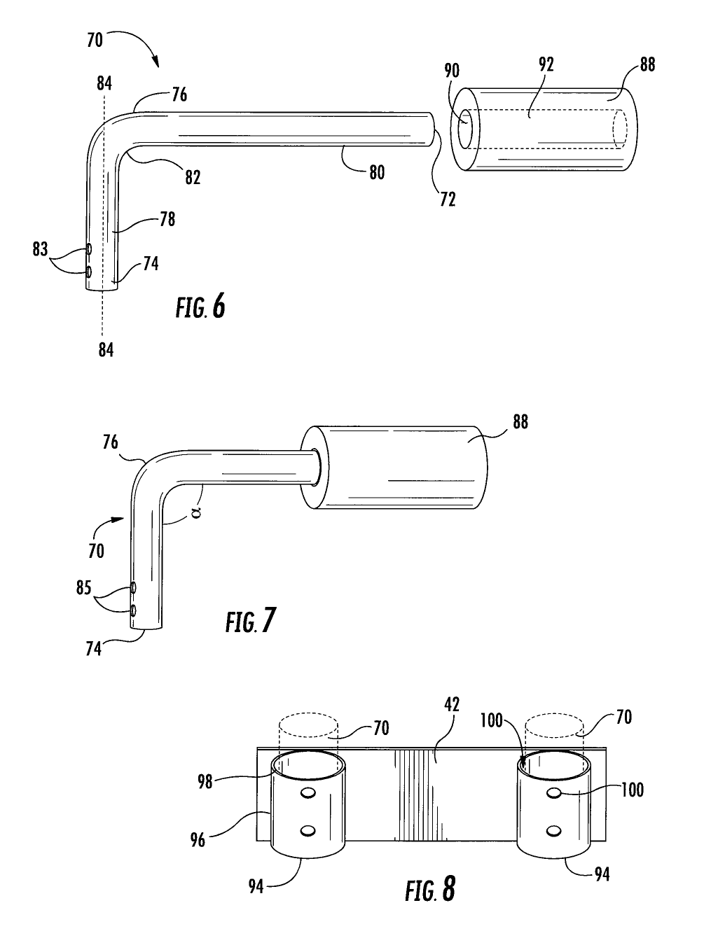

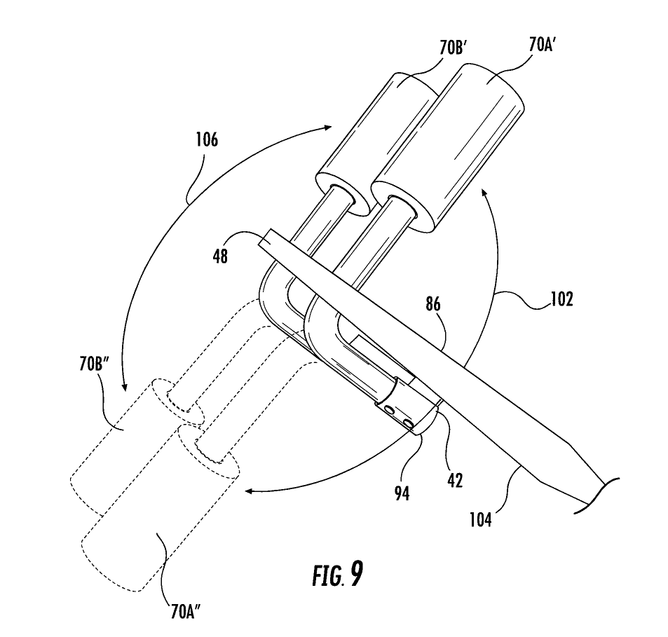

Referring to FIG. 8, an illustrative example of a backrest support frame horizontally arranged bar 42 is shown. The backrest support frame horizontally arranged bar 42 contains a plurality of neck support receiving members 94, illustrated herein as cylindrical bodies 96 attached or integrally formed thereto. The cylindrical bodies 96 contain openings 98 to a portion of the neck support device 70 within the interior 100. A plurality of openings positioned within the surface allow for insertion of screws to maintain the neck support device 70 inserted therein in place. The neck support 70 may be fixed in place or may be designed to rotate/swivel allowing each neck support to be independently or uniformly positioned in the front or back. Referring to FIG. 9, each neck support 70A and 70B can rotate between several positions. Rotating the neck support 70A in the direction of the double arrow 102 allows the neck support to be positioned extending away from the outside surface 86, extending away from back surface (70A′), or locations in between. Rotating the neck support 70B in the direction of the double arrow 106 allows the neck support to be positioned extending away from the outside surface 86, extending away from back surface (70B′), or locations in between.

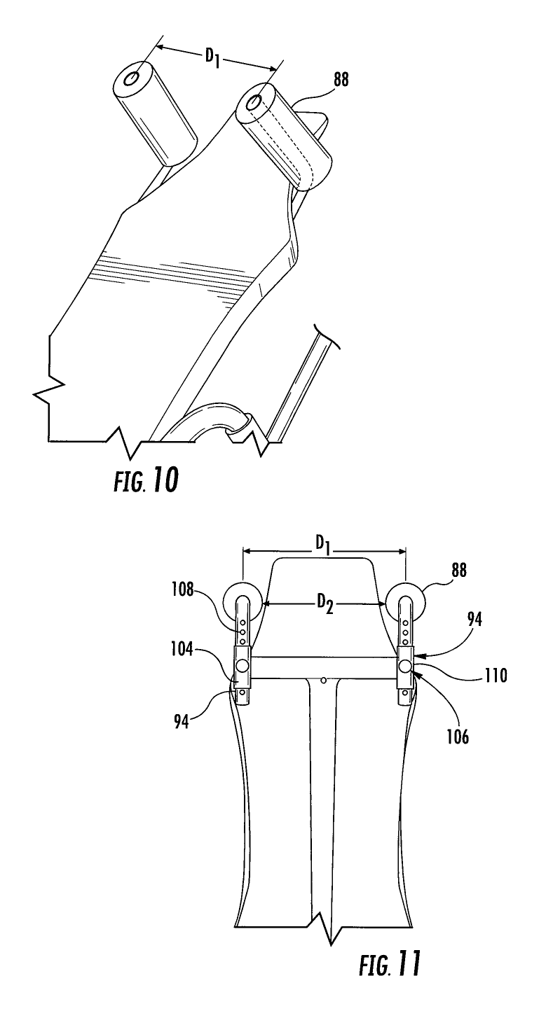

Referring to FIGS. 10 and 11, an alterative embodiment of the inversion table with neck support 10 is shown. In this embodiment, the neck support 70 is designed to provide height adjustment while maintaining a constant distance D1, i.e. distance between the centers of the foam cylindrical members 88, or D2, i.e. the distance between the outer circumferences of the foam cylindrical members 88. Coupled to or integrally formed from the horizontally arranged bar 42 is one or more neck support receiving members 94, illustrated herein as an open cylindrical body or sleeve which allows for portions of the neck support 70 to slide within. The outer surface 104 of the neck support receiving member 94 contains at least one opening 106 which aligns with one or more openings 108 positioned within one or more portions of the neck support 70. Once the desired height of the neck support is obtained, that position is maintained by inserting a pin 110 therein.

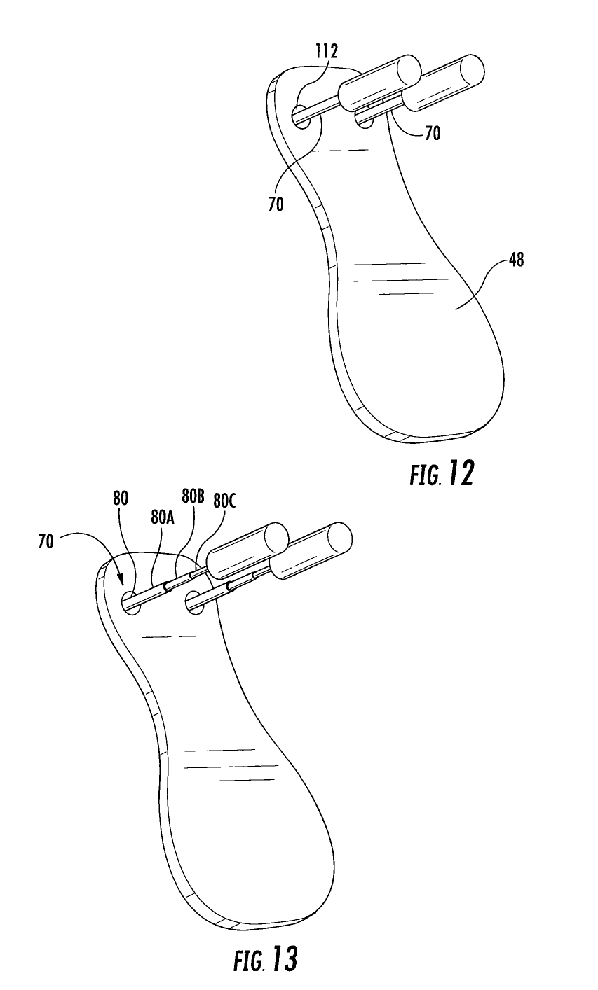

FIGS. 12 and 13 illustrate alternative embodiments of the inversion table with neck support 10 in which portions of the neck support 70 are positioned within and extending through the body support cushion 48 via opening 112. FIG. 13 illustrates neck support 70 having telescoping regions 80A, 80B and 80C, together making up the generally horizontal region 80, which allow for the portions of the neck support 70 to retract into and/or be stored within the body support cushion 48.

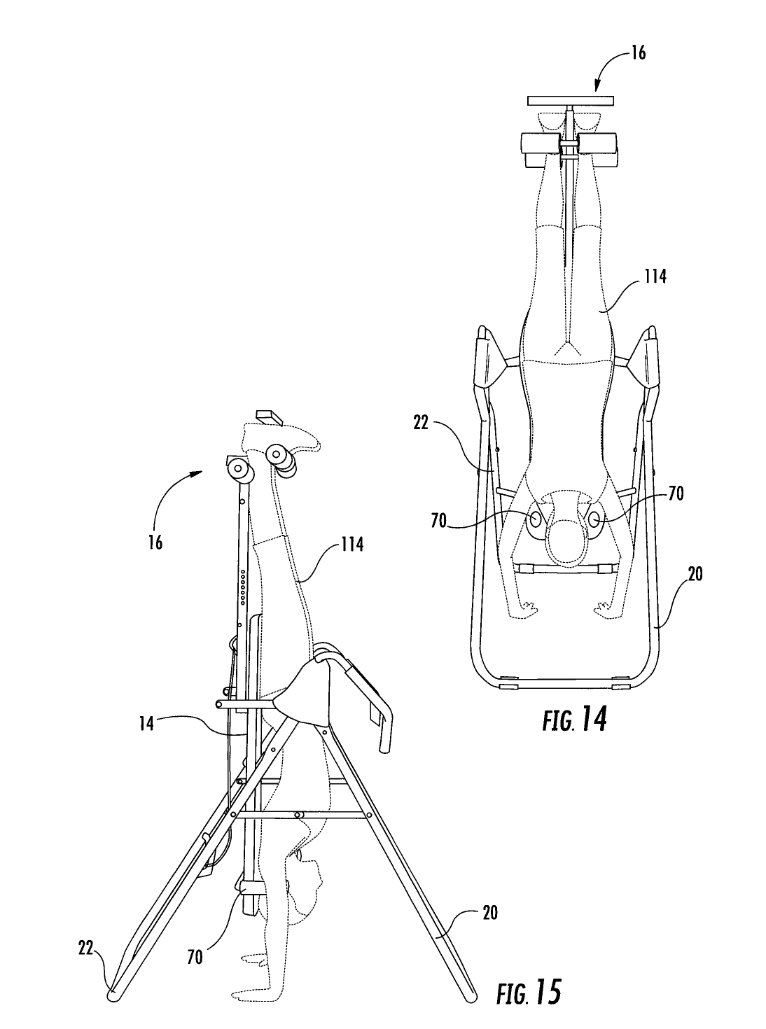

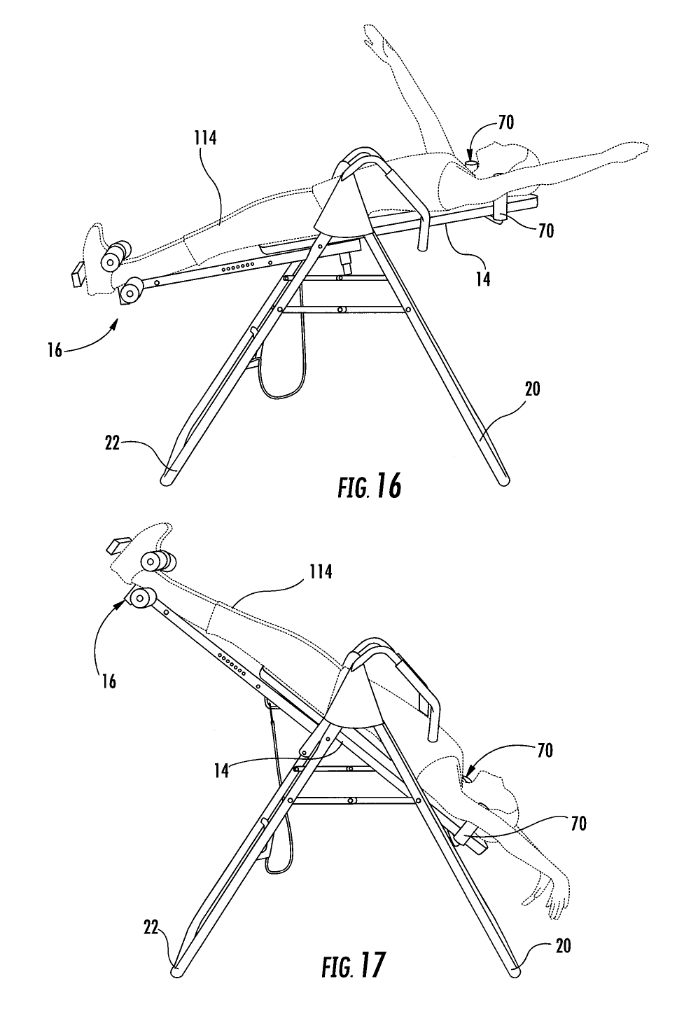

In any of the embodiments described herein, the inversion table with neck support 10 is designed to protect the user from injury associated with inversion or partial inversion. FIGS. 14-17 illustrate a user 114 in the fully inverted position, see FIGS. 14 and 15, and a user in partially inverted positions, see FIGS. 16 and 17. Having the neck support structures 70 protects the user from neck or a spinal injury should they fall while performing an exercise.

All patents and publications mentioned in this specification are indicative of the levels of those skilled in the art to which the invention pertains. All patents and publications are herein incorporated by reference to the same extent as if each individual publication was specifically. and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An inversion table having an enhanced safety feature for minimizing injury to a user when placed in a partially or completely inverted position comprising:
a base frame structure;
back support structure assembly having a back support structure pivotally connected to said base frame structure; and
at least one neck support device adapted to maintain a user's position on said back support structure when in an inverted or partially inverted position.

2. The inversion table having an enhanced safety feature for minimizing injury to a user when placed in a partially or completely inverted position according to claim 1 further including a lower extremity fastening assembly.

3. The inversion table having an enhanced safety feature for minimizing injury to a user when placed in a partially or completely inverted position according to claim 1 further including at least one handle mounted to said base frame structure.

4. The inversion table having an enhanced safety feature for minimizing injury to a user when placed in a partially or completely inverted position according to claim 1 wherein said at least one neck support device is secured to support bracket coupled to the back surface of said back support structure.

5. The inversion table having an enhanced safety feature for minimizing injury to a user when placed in a partially or completely inverted position according to claim 1 wherein said at least one neck support device is rotatably coupled to said back support structure.

6. The inversion table having an enhanced safety feature for minimizing injury to a user when placed in a partially or completely inverted position according to claim 1 wherein at least a portion of said at least one neck support device is slideably coupled to said support bracket coupled to said back surface of said back support structure.

7. The inversion table having an enhanced safety feature for minimizing injury to a user when placed in a partially or completely inverted position according to claim 1 wherein at least a portion of said at least one neck support device further includes a pin for maintaining said at least one neck support in a predetermined position.

8. The inversion table having an enhanced safety feature for minimizing injury to a user when placed in a partially or completely inverted position according to claim 1 wherein said at least one back support structure comprises a first portion coupled to said support bracket coupled to said back surface of said back support structure, and at least one portion extending away from a front surface of said back support structure.

9. An inversion table having an enhanced safety feature for minimizing injury to a user when placed in a partially or completely inverted position comprising:
a base frame structure;
a first assembly for securing one or more portions of a user to said inversion table;
a back support structure assembly pivotally connected to said base frame structure; and
a second assembly for securing a second portion of a user's body to said inversion table, said second portion being independent from said first portion.

10. The inversion table having an enhanced safety feature for minimizing injury to a user when placed in a partially or completely inverted position according to claim 9 wherein said second assembly for securing a second portion of a user's body to said inversion table includes a pair of neck support devices, each said neck support device adapted to maintain a user's position on said back support structure when in an inverted or partially inverted position.

11. The inversion table having an enhanced safety feature for minimizing injury to a user when placed in a partially or completely inverted position according to claim 9 wherein said first assembly for securing a first portion of a user's body to said inversion table is coupled to the back support structure assembly and adapted to secure a user's ankles when said back support structure assembly is inverted.

12. The inversion table having an enhanced safety feature for minimizing injury to a user when placed in a partially or completely inverted position according to claim 9 further including at least one handle mounted to said base frame structure.

13. The inversion table having an enhanced safety feature for minimizing injury to a user when placed in a partially or completely inverted position according to claim 10 wherein each said neck support includes a pad.

14. The inversion table having an enhanced safety feature for minimizing injury to a user when placed in a partially or completely inverted position according to claim 10 wherein the distance between each said neck support is fixed.

15. The inversion table having an enhanced safety feature for minimizing injury to a user when placed in a partially or completely inverted position according to claim 10 wherein the distance between each said neck support is varied.
